(19) United States
(12) Patent Application Publication
(10) Pub. No.: US 2009/0145436 A1
(43) Pub. Date: Jun. 11, 2009

(54) BREATHING APPARATUS AND INSTALLATION PROVIDING PROTECTION AGAINST HYPOXIA

(76) Inventor: Severine Aubonnet, Fontenay-Le-Fleury (FR)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/297,459

(22) PCT Filed: Apr. 20, 2006
(86) PCT No.: PCT/EP06/04587

§ 371 Date: Jan. 23, 2009

(51) Int. Cl. B64D 13/04

(52) U.S. Cl. 128/204.29; 128/204.18

(57) ABSTRACT

The invention relates to a breathing apparatus for an aircraft crew member comprising at least one breathing mask (10) provided with a regulator (12) and an inflatable pneumatic harness (14) for rapid donning of said mask, said regulator being connected to a source of breathable gas (30) through a first feedline, said breathing apparatus further comprising a first buffer plenum (134) having an outlet connected to said pneumatic harness for inflating said harness with compressed gas, and compression means (50) for delivering said compressed gas to said first buffer plenum. The invention also relates to a method for filling the first buffer plenum.

The present invention relates to breathing apparatus for protecting crew members, in particular the technical flight crew, of an aircraft against the risks associated with depressurization at high altitude and/or the occurrence of smoke in the cockpit, or in case of a transfer of the aircraft to its diversion altitude after a depressurization accident.

Nowadays, each airliner pilot has a breathing apparatus comprising a mask fitted with a demand regulator connected to a source of breathing gas. Aviation regulations require that the mask can be put into place and supply oxygen to its wearer in less than 5 seconds. At present, this result is generally achieved by using a mask with a pneumatic harness that can be inflated and deflated, such as one of those described in documents FR-A-1 506 342, FR-A-2 784 900, EP-A-0 628 325, and U.S. Pat. Nos. 5,503,147, 5,590,102, and 5,623,923. The inflated harness allows a rapid donning of the mask on the aircrew member's head. Deflating the harness after donning results in a secure and leak tight fit of the mask against the wearer's face.

The source of gas under pressure must be capable of instantly delivering oxygen or air greatly enriched in oxygen at a pressure which is sufficient for inflating the harness and feeding the regulator of the mask.

On passenger “aircrafts”, the necessary supply of oxygen requires a very large weight. In order to reduce this mass, the oxygen supply can be replaced by an on-board oxygen generator, such as a battery of on-board oxygen generator systems (OBOGS). However, such generators supply air that is highly enriched in oxygen only after a delay has elapsed from the command to supply oxygen. In addition, the output pressure of an OBOGS depends on the rotational speed of the engine and the air supplied is enriched in oxygen to a degree that is variable. The pressure initially available can be too low to inflate the quick-donning harness. The initial degree of enrichment can also be insufficient to protect against hypoxia. A common buffer tank for acting as a supply of very enriched air is placed at the outlet of the OBOGS, but that solution is far from perfect, particularly since the available pressure is insufficient for inflating the harness, as the harness requires at least 2 bar to inflate. Furthermore, the presence of an oxygen transfer pipe causes further delays, and pressure losses.

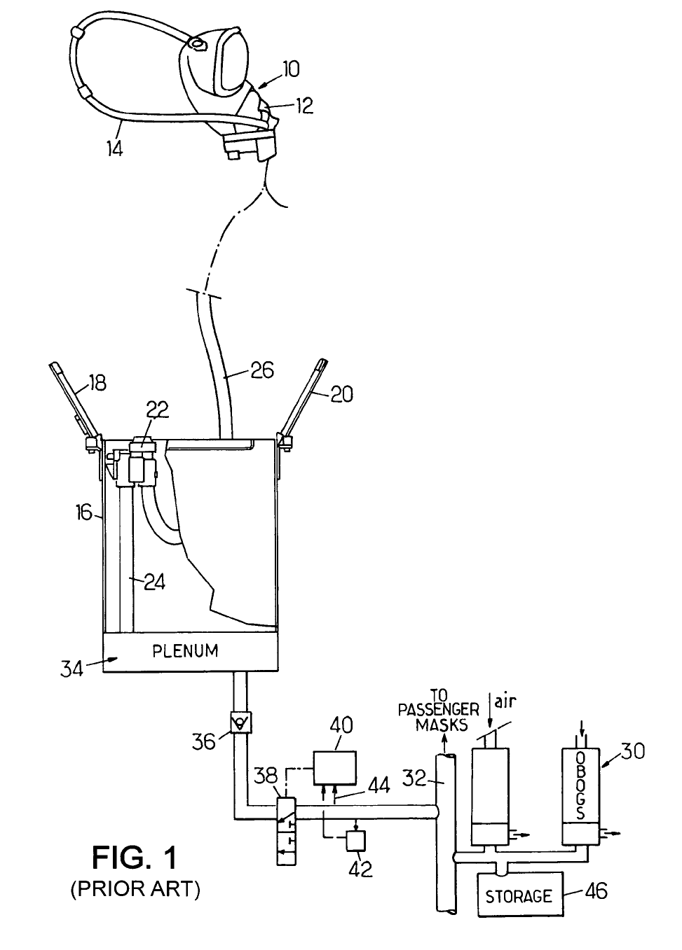

A solution is described in U.S. Pat. Nos. 6,923,193 B2 from the same applicant. As seen in FIG. 1, the disclosed breathing apparatus consists of a breathing circuit that comprises an individual buffer plenum 34 which is placed on the supply line to a crew member mask 10, and interposed between the OBOGS 30 and the regulator 12 of the mask. The breathing circuit further comprises a non return check valve 36 that is placed between the generator 30 and the plenum 34. The system further comprises valve means 38 for preventing initial filing of the buffer until oxygen content and a sufficient pressure are delivered from the OBOGS. The mask 12 may be stored in a box 16 provided with a two flap door 18, 20. A valve 22 carried by the box 16 is interposed between a flexible hose 26 connected to the regulator 12, and a feed pipe 24 connected to the plenum 34.

In steady state conditions of operation, feed pipe 24 receives air highly enriched in oxygen from generator 30. Such a system actually uses the full operating power of the aircraft engines right after take off. Since the pressure from the oxygen enriched air generated by the OBOGS is high during that phase, the plenum buffer can be filled thanks to the non return check valve 36 and valve means 38 with oxygen enriched air under a sufficient pressure to subsequently inflate the head harness in case of need.

As a general rule, an OBOGS delivers pressure that can vary depending on engine speed. For an OBOGS, the delivery pressure may vary over the range 0.5 bars to 3 bars or larger. If the maximum pressure reached when the engines are at full power for climbing may exceed the pressure required to inflate the harness, it is available for only a limited amount of time.

Donning of the mask may be required by the aircrew member during certain phases of the flight, e.g. beyond a given cruising altitude. Furthermore, crew members frequently carry out several mask removal and donning cycles during a flight, either to move out of the cockpit or else. As the take off is the only phase when the OBOGS delivers air under high enough pressure to inflate the harness, several uses of the mask during the flight will cause the plenum to empty its high pressure content into the harness, and through the first breathing cycles if oxygen is also delivered to the mask. After a few removal/donning cycles, inflating the harness becomes impossible as the OBOGS can only deliver low pressure oxygen enriched air during the flight, as the engines are no longer running at full power.

Furthermore, when the source of oxygen is a low pressure source, no existing solution appears satisfactory to inflate the harness.

An object of the present invention is to provide an improved breathing apparatus of the type having an oxygen supply and a mask with an inflatable pneumatic harness. It is a more specific object to provide an apparatus adapted to large capacity airliners having a common supply for the crew and passengers. It is a more particular object to provide an apparatus which guarantees that breathing gas is supplied and multiple rapid donnings are ensured throughout the flight.

To this end, there is provided a breathing apparatus according to claim 1, and a method according to claim 10.

When using an OBOGS, or more generally a source of breathable gas, it is preferable to use a separate inflating circuit with a buffer plenum specifically dedicated to inflating the harness, and that can be refilled throughout the flight thanks to compressions means. Whether the breathing apparatus is provided or not with a second buffer plenum to store oxygen enriched air as described in U.S. Pat. Nos. 6,923,193 B2, an independent circuit is provided to inflate the harness, that adds no constrains on the breathing circuit. First individual buffer plenum can thus be refilled with a compressed gas at any time during the flight, allowing multiple donnings of the mask.

In practice, a plenum for storing 3 to 5 liters of compressed gas suffices. Present mask harnesses generally require a pressure of about 2 to 2.5 bars and a volume of about 1 liter for inflation purposes.

The invention makes it possible to have a plenum filled with compressed gas available to inflate the harness a plurality of times throughout the flight. One does not have to rely solely upon a plenum that can only be filled up once, i.e. when the OBOGS output pressure is higher then 2 to 2.5 bars.

The plenum may be incorporated in a mask storage box. The plenum is then directly connected to a hose feeding the harness of the mask. This configuration only requires a small increase in the size of a box such as that described in document U.S. Pat. No. 6,039,045, or 6,923,193 B2 for example. The invention also relates to a method to refill an individual buffer plenum with a compressed gas as in claim 10.

The above features, and others, will be better understood on reading the following description of particular embodiments, given as non-limiting examples. The description refers to the accompanying drawing.

FIG. 1 is a simplified view of known breathing apparatus, having a full face mask, and shown with the mask out of the storage box;

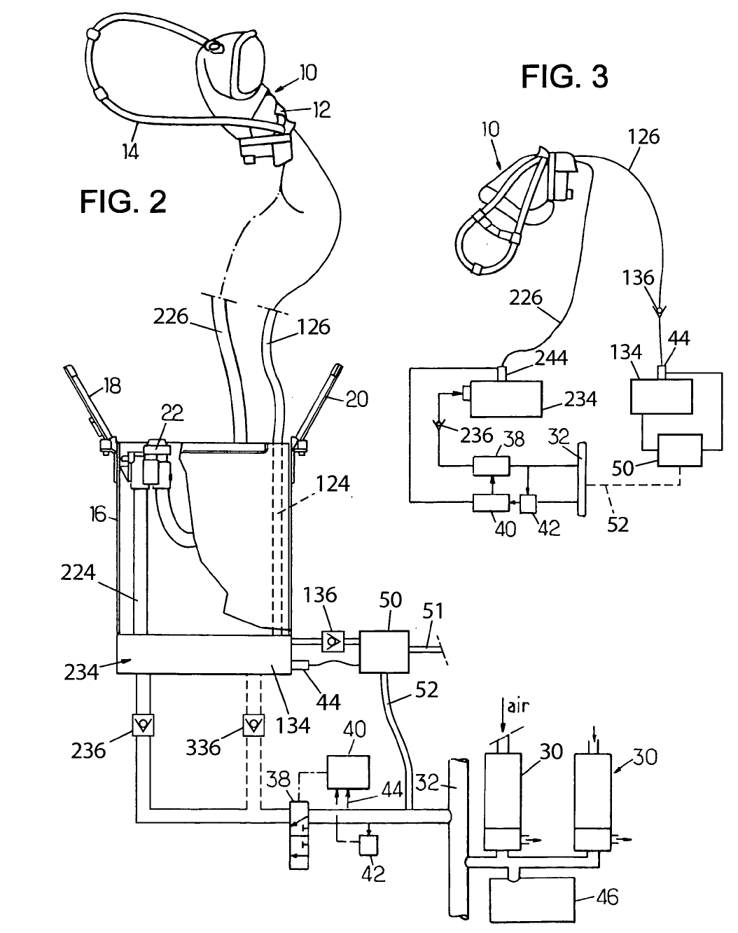

FIG. 2 is a simplified view of breathing apparatus constituting a particular embodiment of the invention, having a full face mask, and shown with the mask out of the storage box; and

FIG. 3 shows a second embodiment of the apparatus according to the invention with no storage box provided.

In the description hereafter, the source of breathable gas is illustrated as, but not limited to, a generator comprising an OBOGS battery. Other examples of sources may be a low pressure breathable gas container or bottles.

The apparatus shown in FIG. 2 comprises a breathing mask 10 with a regulator 12 enabling dilution with ambient air and with a pneumatic harness 14 which can be constituted, in particular, by any one of the various types described in the above-mentioned patent applications. Regulator 12 may be for example a demand regulator or any other type of regulator.

When not in use, the mask and the harness are stored in a box 16 provided with a two-flap door 18, 20. A valve 22 carried by the case of the box is interposed between a flexible hose 226 connected to the regulator of the mask and a feed pipe 224 provided within the box 16. The valve 22 is placed and arranged so as to allow communication of the hose 226 with the pipe 224 when the user of mask 10 pulls the mask out from the box and the flaps 18 and 20 open. In an additional embodiment, the box may also carry a switch for selecting between the different operation modes of the regulator, i.e. with dilution (providing protection against hypoxia only) or without dilution (for providing protection against smoke or at very high altitude). In another embodiment, the switch ensuring such functions may be provided on the mask.

In steady conditions of operation, the pipe 224 receives air highly enriched in oxygen from a generator 30, generally constituted by an OBOGS battery with alternate absorption and delivery cycles. Two OBOGS are shown in FIG. 1. A same single generator feeds a large number of masks. By way of example each OBOGS includes a molecular sieve. Such OBOGS are commercially available, e.g. making use for example of the dispositions described in U.S. Pat. No. 4,561,865, and the prior art cited therein.

In the embodiment of the invention shown in FIG. 2, a feedline provides a connection between the storage box and an outlet manifold 32 of the generator 30. Manifold 32 allows distribution of the oxygen enriched air from the generator 30 to the crew masks and passengers' masks. Distribution to the crew masks is allowed through a specific feedline connected between manifold 32 and either one or a plurality of crew masks. Distribution to the passengers' masks is allowed through feedlines separate from the previous ones as passengers' masks answer different specifications, e.g. no inflatable harness is needed.

Flexible hose 226, valve 22, feed pipe 224 as long as the feedline to manifold 32 are part of a breathing circuit that connects the mask to the source of oxygen enriched air, or breathable gas.

The breathing apparatus according to the invention further comprises as seen on FIG. 2:
a first buffer plenum 134 having an outlet connected to the mask 10, and more specifically to the regulator 12, for feeding the harness 14 with compressed gas,
a compressor 50 for delivering compressed gas to the first buffer plenum 134.

Thus, in the breathing apparatus according to the invention, a separate gas circuit, or a harness inflating circuit, is provided to inflate the harness, with a buffer plenum 134 and compression means 50. This is achieved thanks to a specific feedline that connects the pneumatic harness 14 to the first buffer plenum.

The invention allows to rely throughout the flight upon a dedicated tank filled with a compressed gas at a pressure sufficient to inflate the harness 14.

Compressor 50 ensures that the first buffer plenum 134 is filled to a pressure that is sufficient for inflating harness 14.

In a preferred embodiment, a non-return check valve 136 may be provided between the compressor 50 and the first buffer plenum 134. Check valve 136 guarantees that a volume of gas under a pressure sufficient to inflate the harness is maintained in the buffer plenum 134 even during periods when compressor 50 is not operating.

Buffer plenum 134 may be connected to the harness 14 through the specific feedline that comprises:
a flexible hose 126 connected either directly to the harness 14, or indirectly through the mask 10, and
a feed pipe 124 provided within the box 16 and connecting the plenum 134 to the flexible hose 126.

A valve carried by the case of the box and similar to valve 22 mentioned earlier on may be interposed between flexible hose 126 and feed pipe 124. Such a valve may be placed and arranged so as to allow communication of the hose 126 with pipe 124 when the user of mask 10 pulls the mask out from the box and the flaps 18 and 20 open. Such a valve is not necessary as the compressed air is retained within pipe 124 and hose 126 as long as the user of the mask has not pressed a button provided on said mask to inflate the harness 14.

The gas fed to compressor 50 may come from different sources. Compressor 50 may comprise an inlet 51 open to the ambient air in the aircraft as seen in FIG. 1 so that compressed ambient air can be supplied to the buffer plenum 134.

Another way to derive air to compressor 50 is by feeding the compressor inlet to with air derived from the compressor of one or more of the aircraft engines, i.e. the same air that feeds the OBOGS.

The air from either one of these sources tends to be very humid. An alternative is to feed the compressor 50 with dry air.

In an alternative embodiment of the invention, compressor 50 may comprise an inlet connected to the outlet of the source of breathable gas 30, for example either through feedline 52 as seen in FIG. 2 that connects compressor 50 on the feed line to the mask 10 downstream manifold 32. Other connection means may be provided to either connect compressor 50 to the source of breathable gas outlet or to a storage tank 46 downstream the source 30. Thus compressed oxygen enriched air can be supplied to the first buffer plenum 134. Such air is dryer then the above mentioned sources of air and can therefore suppress any problems linked to humidity.

As several consecutive donning of the mask will empty the first buffer plenum 134 from its compressed gas, in a preferred implementation of the breathing apparatus according to the invention, compression 50 is activated when the pressure of the first buffer plenum P decreases below a first given value P₁, and is deactivated when its pressure increases beyond a second given value P₂. With consecutive inflating/deflating cycles of harness 14, the pressure level in buffer plenum 134 will decrease as the buffer gets depleted from its compressed air. Compressed gas is then needed for the next use of the harness. The compressor is triggered when the pressure P inside the plenum 134 decreases below P₁, with P₁ within the [2.0, 2.5] bar range or higher to ensure proper harness inflating.

The first buffer plenum 134 is then filled to a pressure that is sufficient for inflating the harness 14.

In order to avoid overpressure in the plenum 134, and ease its sizing, compressor may be cut off when P exceeds P2, e.g. 5 to 6 bars, or a pressure level that allows several consecutive donnings without requiring too much time to be reached, or too large a compressor.

To measure the buffer plenum pressure, a pressure sensor 44 may be provided on the first buffer plenum 134, its reading being transmitted to the compressor and/or to an electronic control module that drives said compressor.

In an alternative embodiment, to activate or deactivate compression means 50, a first pressure switch (not shown) may be provided in the first buffer plenum 134 for activating compression means 50 when the pressure P inside said plenum decreases below P₁. A second pressure switch (not shown) is then provided to activate compression means 50 when P increases beyond P₂.

As seen in FIG. 2, the breathing circuit mentioned earlier may comprise a second buffer plenum 234 provided on the feedline between manifold 32 and crew mask 10, as described in U.S. Pat. No. 6,923,193 B2. The second buffer plenum 234 has at least an outlet connected to the mask for feeding the regulator 12 through pipe 224 and feedline 226.

In an additional embodiment of the apparatus according to the invention, a control valve (typically a solenoid valve) 38 is provided on the feedline upstream the non return check valve 236, to control the oxygen content fed to plenum 234.

In the illustrated embodiment in FIG. 2, the storage box is provided with the first buffer plenum 134 and the second buffer plenum 234. In a variant embodiment, buffer plenum 134 may be provided in a different location separate from the storage box 16.

In the modified embodiment shown in FIG. 3, mask 10 is designed to be stored other than in a mask box. The breathing apparatus according to the invention comprises a first buffer plenum 134 having an outlet connected to the mask 10, and more specifically to the harness 14, for feeding said harness with a compressed gas, and a compressor 50 for delivering the compressed gas to the first buffer plenum 134.

In a preferred embodiment, a non-return check valve 136 may be provided between the compressor 50 and the first buffer plenum 134. Check valve 136 guarantees that a volume of air under a pressure sufficient to inflate the harness is maintained in the buffer plenum 134 even during periods when compressor 50 is not operating.

Buffer plenum 134 may be connected to the harness 14 thanks to a flexible hose 126 connected either directly to the harness 14, or indirectly through the mask 10. As with the first embodiment, compressor 50 may derive its incoming gas from either the ambient air in the aircraft, air derived from the compressor of one or more of the aircraft engines or gas from a source of breathable gas, e.g. from feedline 52 in doted lines on FIG. 2 connected to manifold 52 or directly to the source outlet.

In a preferred embodiment, a pressure sensor 44 is provided to measure the plenum pressure P and allow either the activation (if P decreases below P₁) or deactivation (if P increases above P₂) of compressor 50, as in the first embodiment. As mentioned before, pressure switches may be provided in plane of pressure sensor 44.

Regarding the breathing circuit, mask 10 is connected by the flexible hose 226 directly to manifold 32 or to a separate plenum 234. The connection between the plenum 234 and manifold 32 includes a non-return check valve 36.

A solenoid valve 38 may be also provided and is connected to a control module 40 which puts the manifold 32 into communication with the check valve 36 when the oxygen content as measured by a gas analyzer 42 exceeds a determined value.

The breathing apparatus according to the invention allows several donnings of the mask throughout a flight. Compression means 50 allows to refill the plenum with gas under high enough pressure to inflate again the harness of a mask. This is achieved thanks to the inflating circuit that has no connection to the regulator as the inflating circuit and the breathing circuit are separate.

The compression means 50 may be a compressor. Such compression may be a compressor of the type having a linear electric motor. This motor comprises a moving piston slidably mounted in a cylinder attracted by an electromagnet and repelled by a spring. The intake orifice of the compressor is connected to the ambient air, or air derived from the compressor of one or more of the aircraft engines, or to the source 30 of breathable gas. The discharge orifice of the compressor is connected to non return check valve 36 when provided, or directly to plenum 134 other. Other types of compressors may be but not limited to, an hydraulic compressor, an electromagnetic compressor, a volumetric compressor.

Compressor 50 may be shared to fill several buffer plenums with compressed air, in case the compressor 50 is common to all or a cluster of crew masks. A large plenum 134 may also be envisaged for feeding several mask harnesses, its pressure being controlled by a unique compressor large enough to support inflating a plurality of harnesses.

Numerous possible modifications will immediately appear to those familiar with the relevant art. For instance a same plenum of increased capacity can be shared between two pilots.

In a preferred embodiment, the first buffer plenum as well as the compression means may be located close to the mask and the storage box when provided, e.g. within the cockpit of the aircraft.

1. A breathing apparatus for an aircraft crew member comprising at least one breathing mask provided with a regulator and an inflatable pneumatic harness for rapid donning of said mask, said regulator being connected to a source of breathable gas through a first feedline, said breathing apparatus further comprising:
a first buffer plenum having an outlet connected to said pneumatic harness for inflating said harness with a compressed gas,
compression means for delivering said compressed gas to said first buffer plenum; wherein the pneumatic harness is connected to the first buffer plenum through a second feedline distinct from the first feedline.

2. (canceled)

3. A breathing apparatus according to claim 1, further comprising a non return check valve provided between the first buffer plenum and the compression means.

4. A breathing apparatus according to claim 1, wherein the compression means comprises an inlet open to the ambient air in the aircraft so that compressed ambient air can be supplied to the first buffer plenum.

5. A breathing apparatus according to claim 1, wherein the compression means comprises an inlet connected to the outlet of the source of breathable gas, so that compressed breathable gas can be supplied to the first buffer plenum.

6. A breathing apparatus according to claim 1, wherein the compression means comprises an inlet fed with air derived from the compressor of one or more of the aircraft engines, so that compressed air can be supplied to the first buffer plenum.

7. A breathing apparatus according to claim 1, wherein the compression means is activated when the pressure of the first buffer plenum decreases below a first given value (P₁), and is deactivated when the pressure of the first buffer plenum increases beyond a second given value (P₂).

8. A breathing apparatus according to claim 7, further comprising a pressure sensor provided on the first buffer plenum to measure said first buffer plenum pressure, the compression means being activated when the measured pressure decreases below a first given value (P₁), and is deactivated when measured pressure increases beyond a second given value (P₂).

9. A breathing apparatus according to claim 7, further comprising a first pressure switch for activating the compression means when the pressure of the first buffer plenum decreases below the first given value, and a second pressure switch for deactivating said compression means when the pressure of said first buffer plenum increases beyond the second given value.

10. A method to refill a buffer plenum with compressed gas, said buffer plenum being comprised in a breathing apparatus for an aircraft crew member, said apparatus comprising:
at least one breathing mask provided with a demand regulator and a pneumatic harness inflatable with said compressed air in said buffer plenum for rapid donning of said mask,
a source of breathable gas connected to said regulator through a first feedline,
compression means for delivering compressed air to said plenum, wherein the compression means is activated when the pressure of the buffer plenum decreases below a first given value (P₁), and is deactivated when the pressure of the buffer plenum increases beyond a second given value (P₂), and the pneumatic harness is connected to the buffer plenum through a second feedline distinct from the first feedline.
